(19) United States
(12) Patent Application Publication
(10) Pub. No.: US 2004/0196865 A1
(43) Pub. Date: Oct. 7, 2004

(54) Method and system for discovering a topology of a portion of a computer network

(76) Inventors: Srikanth Natarajan, Ft. Collins, CO (US); Richard David Lamb, Ft. Collins, CO (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/397,620

(22) Filed: Mar. 27, 2003

(51) Int. Cl. H04J 3/16; H04L 12/28

(52) U.S. Cl. 370/465; 370/400

(57) ABSTRACT

A system and method includes obtaining first information from a first router that supports a first routing protocol (for example, OSPF) in a computer network. The routing protocol defines areas, which are groups of routers, and defines neighbors. The first information includes a first routing protocol neighbor indication and a first routing protocol area indication. The first routing protocol neighbor indication is used to determine a second router that supports the first routing protocol in the computer network. Second information is obtained from the second router. The second information includes a second routing protocol neighbor indication and a second routing protocol area indication. The information can be discovered and collected iteratively until a topology of a desired portion of the network which supports the first routing protocol can be produced.

### BACKGROUND

Computer networks, such as Local Area Networks (LANs) and Metropolitan Area Networks (MANs) can be complex to operate. Corporations use network management software applications to maintain computer networks. The network management software applications can display the network topology and indicate any failures in the computer network. An example of a network management software application, is the Hewlett-Packard OpenView Network Node Manager (NNM) product.

To produce a display in a network management software application, data from nodes of the computer network is obtained. A management protocol such as the Simple Network Management Protocol (SNMP) can be used to get from nodes of the computer network. This information can be stored for later use by the network management software application.

### SUMMARY

A system and method are disclosed for discovering routers which support a first routing protocol to produce a topology of a portion of a computer network which supports the first routing protocol. The discovered information can be used for producing a display of a portion of the computer network. An exemplary method includes obtaining first information from a first router that supports the first routing protocol in the computer network. The routing protocol defines areas, which are groups of routers, and defines neighbors. The first information includes a first routing protocol neighbor indication and a first routing protocol area indication. The first routing protocol neighbor indication is used to determine a second router that supports the first routing protocol in the computer network. Second information is obtained from the second router. The second information includes a second routing protocol neighbor indication and a second routing protocol area indication. The first and second information is used to produce a topology of the portion of the computer network that supports the first routing protocol. An exemplary machine readable medium includes software for causing a computing device to perform the exemplary method. An exemplary apparatus for discovering routers which support a first routing protocol to produce a topology of a portion of the computer network which supports a first routing protocol including means for obtaining first information from a first router that supports a first routing protocol in the computer network, the routing protocol defining areas which are groups of routers and defining neighbors, the first information including a first routing protocol neighbor indication and a first routing protocol area indication, the processor configured to use the first routing protocol neighbor indication to determine a second router that supports the first routing protocol in the computer network, the processor configured to obtain second information from the second router, the second information including a second routing protocol neighbor indication and a second routing protocol area indication, and means for storing the first and second information to produce topology information of a portion of the computer network that supports the first routing protocol.

In accordance with an exemplary embodiment, a system for discovering routers which support a first routing protocol to produce a topology of a portion of the computer network which supports the first routing protocol. The computer includes a processor configured to obtain first information from a first router that supports a first routing protocol in the computer network. The routing protocol defines areas, which are groups of routers, and defines neighbors. The first information includes a first routing protocol neighbor indication and a first routing protocol area indication. The processor is configured to use the first routing protocol neighbor indication to determine a second router that supports the first routing protocol in the computer network. The processor is configured to obtain second information from the second router. The second information includes a second routing protocol neighbor indication and a second routing protocol area indication. A memory stores the first and second information to produce topology information of a portion of the computer network that supports the first routing protocol.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 is an exemplary flow chart for producing a display of a computer network;

FIG. 2 is a diagram of a computer network that illustrates a collection of information according to an exemplary embodiment;

FIG. 3 is a diagram of an exemplary computer network display;

FIG. 4 is a diagram of an exemplary computer network display; and

FIG. 5 is a diagram of an exemplary computer implementation.

### DETAILED DESCRIPTION OF THE PREFERRED EMBODIMENTS

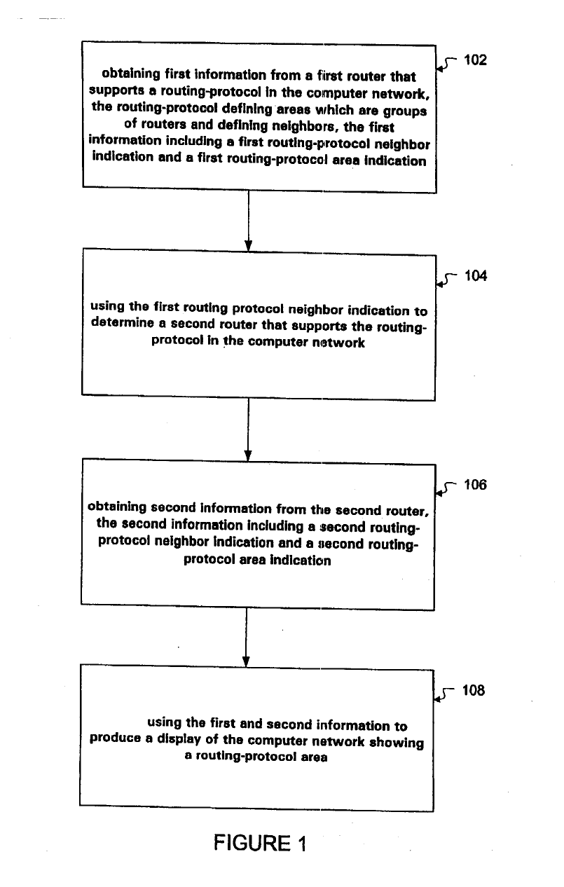

FIG. 1 is a flowchart illustrating a method of discovering the routing nodes which support a first routing protocol for purposes of acquiring the topology of a portion of the computer network which support the first routing protocol. The information can be used to, for example, produce a display of the nodes in the computer network. The network can include nodes that support one or more, routing protocols.

In step 102, first information is obtained from a first router that supports a first routing protocol in the computer network. In exemplary embodiments, the first router can be selected in any desired fashion including, but not limited to, a random selection by the network administrator or other user, or automatically by the system. Alternately, the selection can be in response to the provision of an Internet Protocol (IP) address of a router known to support the first routing protocol. The first router can, for example, be a router included in a backbone (e.g., an area designated “0”) of the computer network.

A routing protocol can be, for example, an Open Shortest Path First (OSPF) routing protocol, and an exemplary embodiment will be described in the context of OSPF. The OSPF TCP/IP Internet routing protocol is classified as an Interior Gateway Protocol (IGP), which distributes routing information between routers belonging to a single Autonomous System. The OSPF routing protocol was developed by the OSPF working group of the Internet Engineering Task Force (IETF). However, those skilled in the art will appreciate that any other routing protocol can be used provided procedures are implemented, so that information as described herein can be acquired from nodes which support the routing protocol.

The OSPF routing protocol is described in a Request For Comment (RFC) 2178 of the IETF, (published via the Internet in July of 1997) and comprising 211 numbered pages. The routing protocol can be used to define areas, which are groups of routers, and neighbors. In one example, the areas are groups of routers that support a particular routing protocol.

Where the network includes at least some nodes which support OSPF, the areas can be defined as OSPF areas. An OSPF area is a group of one or more routers for which the details of some of the interior of the area are kept hidden from routers outside of the OSPF area. The first information can include first routing protocol neighbor indications and first routing protocol area indications. With OSPF, this information is maintained as data encapsulated in a Management Information Base (MIB) of each OSPF router, and can be acquired by querying an agent of the MIB of each such router as described herein.

In Step 104, the first routing protocol neighbor indication is used to determine a second router that supports the routing protocol in the computer network. In step 106, the second information is obtained from the second router. The second information can include a second routing protocol neighbor indication and a second routing protocol area indication. This process can be repeated “n” times iteratively, until all routers of a defined network (that is, an entire computer network or any portion thereof) which support the first routing protocol have been queried either directly, or indirectly (e.g., the information for a second router was obtained from a first router or other device that communicates with the second router).

The information acquired from the routers which support the first protocol (e.g., the OSPF routers of a network), can be used for any of a number of applications. For example, in one application, this information can be used to produce a display of only those nodes in the network which constitute OSPF routers, such that the OSPF operation of the computer network can be viewed in isolation. In Step 108, the first and second information is used in an application to produce a display of a computer network showing a routing protocol area.

OSPF protocols are a type of dynamic routing protocol. In dynamic routing protocols, routers communicate with other routers to obtain routing information. As opposed to static protocols, the information stored in the routing tables of routers supporting a dynamic routing protocol can change over time.

The OSPF routing protocol can run over an autonomous system (AS) controlled by the same entity and, in an exemplary embodiment, each OSPF router in an OSPF area maintains an identical topology database describing the autonomous system topology. OSPF is a link state based routing protocol where the topological database is produced at the routers from link state advertisements generated by the routers. As such, using this database, a routing table can be calculated by constructing a shortest path tree.

The OSPF protocol operates hierarchically. For example, a hierarchy can be established whereby the largest entity in the hierarchy is the Autonomous System, representing a collection of networks under common administration that share a common routing strategy. The autonomous system can be divided into a number of different areas, which are associated with networks and hosts. To route within an area, routers outside the area route to an Area Border Router (ABR). Area Border Routers are routers at the edge of the area that connect to routers outside the area.

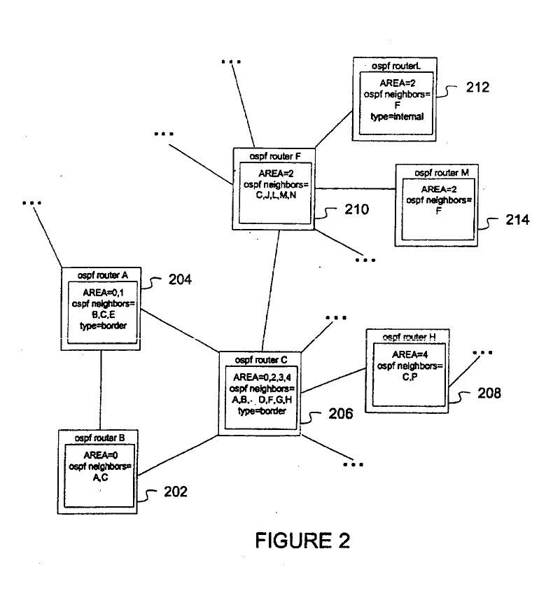

In operation, the method of FIG. 1 can be run as part of an OSPF discovery process to output a static list of all paths between OSPF routers in the network. FIG. 2 is a diagram of a computer network that illustrates a collection of information according to an exemplary embodiment. In one example, information is obtained concerning the area and the neighbors of a first node, such as the OSPF router 202. In this case, OSPF router 202 is part of the area 0 (or backbone of the network), and its neighbors include routers 204 and 206.

Using this information, the system can also determine from router 206, that it is an Area Border Router that is part of areas 0, 2, 3, and 4. The neighbors for the OSPF router 206 include routers A, B, D, F, G, and H, not all of which are shown in FIG. 2. The border router 206 can have a topology database and routing table for each area of which it is a member. In this example, where the router 206 is a member of areas 0, 2, 3, and 4, it can maintain a topology database and routing table for each of these OSPF areas.

The pseudocode listed below illustrates an exemplary method by which queries are used to collect information concerning the computer network to, for example, produce a display:

```
set starting router as current router
until done flag is set
          get OSPF area, area border status, OSPF neighbor routers
of current router, and OSPF router ID
          check OSPF neighbor routers against known router list
          push unknown neighbors onto stack and add unknown
neighbors to known list
          If stack is not empty
              pop router from the stack
              set popped router as current router
          else
              set done flag
```

In the foregoing pseudocode, information concerning the OSPF area, area border status, neighbors, and OSPF router ID constitute object identities contained within the MIB of an OSPF router, and this information is obtained from the router using the “get” query. As this information is acquired iteratively for the routers of a network, paths between router interfaces can be identified. That is, end-to-end connection paths between routers can be identified. Interface information is included in the routing tables of each router, and this interface information, as it is acquired from neighboring routers, can be compared to identify those interfaces of plural routers which are connected to form the end-to-end paths.

Using the example of FIG. 2, a starting router is selected (e.g., router B), and this starting router is set as the current router. Router B is then added to the “known list”. The “known list” can be maintained to cache generic router information (e.g., router information that would be common to all interfaces of the router and thereby potentially decrease the numbers of queries. For example, where router B is a neighbor to routers A and C, the information for B can be stored so that it need not be reacquired when router B is later identified by routers A and C as their neighbor.

The OSPF area, area border status, and OSPF neighbor routers of the router B (in this case, routers A and C) are obtained. Routers A and C are added to a stack which keeps track of those routers which have not yet been queried (e.g., a first-in last-out memory device, or any other type of memory). That is, the stack maintains a list of the nodes to be visited, and since neither A and C are on the known list, they are added to the stock. After router B has been queried, a router is popped from the stack. In this case, router C is popped from the stack. The OSPF area, area border status, and OSPF neighbor routers of router C are obtained. In querying router C, its neighbors A, B, D, F, G, and H are discovered. Since B, and C are already in the known list, and A is already in the stack, only the new nodes D, F, G and H are pushed on the stack. This process can be repeated iteratively until all routers of the computer network are known, along with their interrelationship within the network. Using this method, all of the routers in the entire Autonomous System, or any portion thereof, can be found.

The pseudocode above illustrates a system in which a depth first search is performed. Alternately, or in addition, a breadth first search or any other type of search can be performed to determine the topology information.

As mentioned, the information from the routers can be obtained using management protocol requests in the above pseudocode. In one example, IETF Request For Comment (RFC) 1253 (published via the Internet by the IETF in August 1991) and comprising 42 numbered pages or IETF Request For Comment 1850 (published via the Internet by the IETF in November 1995 and comprising 80 numbered pages), queries to Management Information Base (MIB) information at the OSPF routers, in accordance with OSPF standards, can be used to obtain the information. RFC 1253 and RFC 1850 implement MIB support for OSPF Version 2. The collected information can be cached, and indexed using the OSPF Router identification (ID), so that router generic information (that is, information that is common on a router, independent of IP interface) only has to be obtained once. This caching also allows the discovery engine to determine if it has already visited a particular OSPF router, and can be used to avoid collecting information from this router again, if it has.

In an exemplary embodiment, a display can be produced from the collected information to show end-to-end connections between routers which support a particular routing protocol within the routing protocol area. This display can be used by a network administrator to manage the network (e.g., to redefine the routers within given areas).

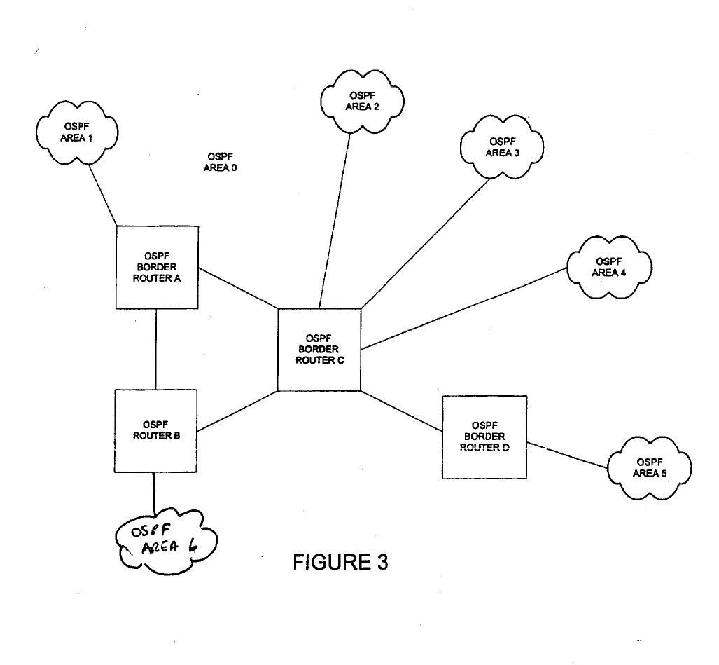

FIG. 3 shows an exemplary display of routers of an area that can be produced on a graphical user interface (GUI). The collected information concerning the routers can be used to produce a display such as that shown in FIG. 3. The collected information can be searched to determine the routers of any designated area for display. In the example of FIG. 3, routers A, B, C, D are part of area 0 which constitutes a backbone of the computer network, and can be seen to serve five areas in the example shown. The neighbor indications acquired during the discovery process can be used to produce the displayed links between the routers. For example, router A indicates that Router B is a neighbor router, so a link between Router A and Router B is shown in the display. The connections to other areas can be determined by examining information from the Area Border Routers within the area, such as routers A, C, D of FIG. 3 (that is, by examining the areas of neighbor routers to which the Area Border Routers connect).

In an exemplary embodiment, the display can show multiple routing protocol areas. In the example of FIG. 3, the multiple routing protocol routers of area 0 are shown, and indications of areas 1, 2, 3, 4, 5 and 6 are shown as general areas of connection.

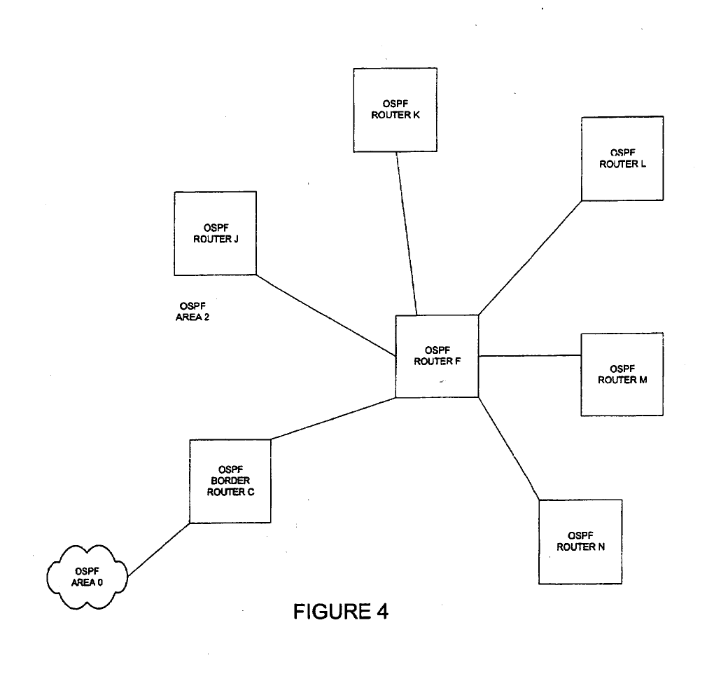

In an exemplary embodiment, the display can show any selected routing protocol area connected to the backbone. For example, in FIG. 3, area 1 is shown as connected to backbone routing protocol router A, areas 2-4 are shown as connected to router C, area 5 is shown as connected to router D, and area 6 is shown as connected to router B. In this exemplary embodiment, the network is displayed by areas, and clouds are used to establish links for traversing between areas. The clouds therefore identify border routers. The FIG. 3 display can be accessed, in an exemplary embodiment, using a topology index page (e.g., an index page wherein a user selectable option includes discovery of OSPF routers). Once the FIG. 3 display is produced, it can then be used by the network administrator to access any OSPF area. For example, if Area 2 is selected in the FIG. 3 display, FIG. 4 will be presented.

In one embodiment, the selection between multiple views can be provided. For example, a network administrator can select among a first and second view using, for example, links contained in the views which allow the administrator to switch between views. The first view can, for example, show routing protocol routers within a routing protocol area and the second view can, for example, show the routing protocol area connected to a backbone routing protocol router.

FIG. 4 is an example of a first view showing routers of an area, in this case area 2. FIG. 3 is an example of a second view showing an area connected to backbone routing protocol router; in this case, area 2 is connected to backbone router C. The selection of a view can be performed by selecting an element, such as a routing node, in another view (e.g., by moving a cursor to the element and clicking upon it). For example, by selecting the area 0 indication of FIG. 4, the view of FIG. 3 will be produced.

Various aspects will now be described in connection with exemplary embodiments in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both. Moreover, the exemplary embodiments can be considered part of any form of computer readable storage medium having stored therein an appropriate set of computer instructions that would cause a processor to carry out the techniques described herein.

Thus, the various aspects can be embodied in many different forms, and all such forms are contemplated to be within the scope of what is described. For each of the various aspects, any such form of embodiment can be referred to herein as “logic configured to” perform a described action, or alternatively as “logic that” performs or “logic capable of” performing a described action.

The system and method for showing the routing protocol areas can be integrated as part of any computer network display system. For example, the system can be integrated into HP OpenView Network Node Manager (NNM).

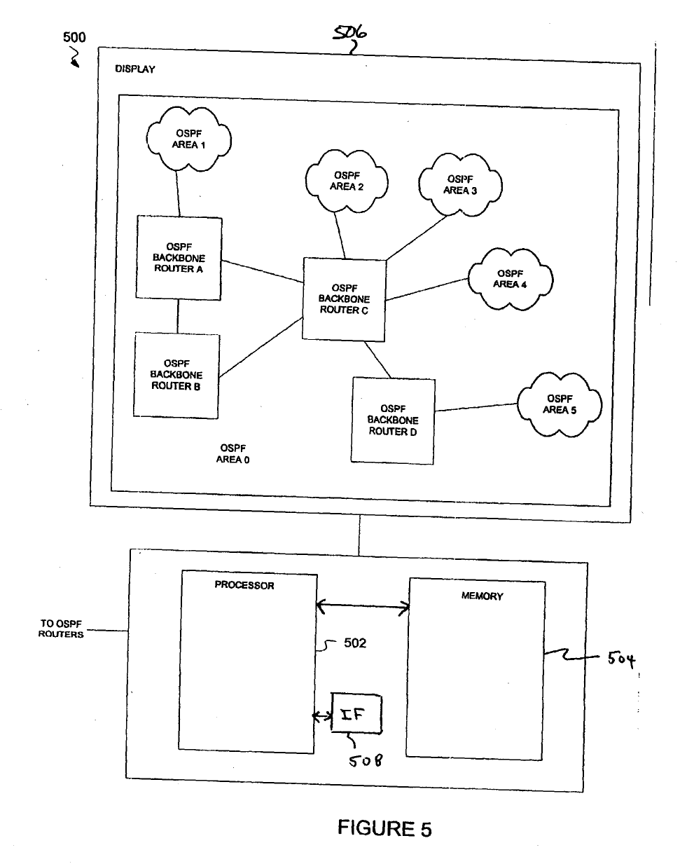

FIG. 5 illustrates an exemplary computer system implementing a discovery of the topology of a designated routing protocol, and an application of the discovered topology to the production of display. Computer 500 includes a means for obtaining, represented, for example, as a processor 502 configured to obtain first information from a first router that supports a first routing protocol (e.g., OSPF) in a computer network. The routing protocol defines areas, which are groups of routers, and neighbors. The first information includes a first routing protocol neighbor indication and a first routing protocol area indication. The processor is configured to use the first routing protocol neighbor indication to determine a second router that supports the first routing protocol in the computer network. The processor is configured to obtain second information from the second router. The second information includes a second routing protocol neighbor indication in a second routing protocol area indication. This operation can be repeated iteratively until all routing nodes which support a designated routing protocol have been discovered. A means for storing, represented, for example, as a memory 504 that stores the first and second information to, for example, produce topology information of a portion of the computer network that supports the first routing protocol. The computer 500 also includes a means, represented, for example, as a display 506 that uses the topology information to show a routing protocol area.

The display can show the routing protocol nodes within the routing protocol area. The display can show multiple routing protocol areas, and show the routing protocol area connected to a backbone routing protocol. The system includes an interface 508 (e.g., on the display, and/or mouse or keypad) for selection between a first view showing a routing protocol routers within the routing protocol area and a second view showing the routing protocol area connected to a backbone routing protocol router.

Those skilled in the art will appreciate that software, including instructions for causing a computing device or system to perform the methods or processes described herein, can be stored on a machine-readable medium. For example, the software can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used herein, a “computer readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non exhaustive list) of the computer readable medium can include the following: an electrical connection having one or more wires, a portable computer diskette, a random access memory (RAM), a read only memory (ROM), an erasable programmable read only memory (EPROM or Flash memory), an optical fiber, and a portable compact disc read only memory (CDROM).

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method of discovering routers which support a first routing protocol to produce a topology of a portion of a computer network which supports the first routing protocol, the method comprising:
obtaining first information from a first router that supports a routing protocol in the computer network, the routing protocol defining areas which are groups of routers and defining neighbors, the first information including a first routing protocol neighbor indication and a first routing protocol area indication;
using the first routing protocol neighbor indication to determine a second router that supports the first routing protocol in the computer network;
obtaining second information from the second router, the second information including a second routing protocol neighbor indication and a second routing protocol area indication; and
using the first and second information to produce a topology of the portion of the computer network that supports the first routing protocol.

2. The method of claim 1, wherein the first routing protocol is an OSPF protocol.

3. The method of claim 1, comprising:
displaying routing protocol routers within a routing protocol area.

4. The method of claim 3, wherein the displaying includes:
displaying multiple routing protocol areas.

5. The method of claim 3, wherein the displaying includes:
displaying a routing protocol area connected to a backbone routing protocol router.

6. The method of claim 3, comprising:
selecting between a first view showing routing protocol routers within the routing protocol area, and a second view showing the routing protocol area connected to a backbone routing protocol router.

7. A system for discovering routers which support a first routing protocol to produce a topology of a portion of the computer network which supports a first routing protocol:
a processor configured to obtain first information from a first router that supports the first routing protocol in the computer network, the routing protocol defining areas which are groups of routers and defining neighbors, the first information including a first routing protocol neighbor indication and a first routing protocol area indication, the processor configured to use the first routing protocol neighbor indication to determine a second router that supports the first routing protocol in the computer network, the processor configured to obtain second information from the second router, the second information including a second routing protocol neighbor indication and a second routing protocol area indication; and
a memory which stores the first and second information to produce topology information of a portion of the computer network that supports the first routing protocol.

8. The system of claim 7, wherein the first routing protocol is an OSPF protocol.

9. The system of claim 7, comprising:
a display using the topology information to show a routing protocol area.

10. The system of claim 9, wherein the display shows routing protocol nodes within the routing protocol area.

11. The system of claim 9, wherein the display shows multiple routing protocol areas.

12. The computer of claim 9, wherein the display shows the routing protocol area connected to a backbone routing protocol router.

13. The computer of claim 9, wherein the processor includes an interface for selection between a first view showing routing protocol routers within the routing protocol area and a second view showing the routing protocol area connected to a backbone routing protocol router.

14. The system of claim 10, wherein the first routing protocol is an OSPF protocol.

15. A computer readable medium containing a computer program for performing a method of discovering routers which support a first routing protocol to produce a topology of a portion of a computer network which supports the first routing protocol, the method comprising:
obtaining first information from a first router that supports a routing protocol in the computer network, the routing protocol defining areas which are groups of routers and defining neighbors, the first information including a first routing protocol neighbor indication and a first routing protocol area indication;
using the first routing protocol neighbor indication to determine a second router that supports the first routing protocol in the computer network;
obtaining second information from the second router, the second information including a second routing protocol neighbor indication and a second routing protocol area indication; and
using the first and second information to produce a topology of the portion of the computer network that supports the first routing protocol.

16. The method of claim 15, wherein the first routing protocol is an OSPF protocol.

17. The method of claim 15, comprising:
displaying routing protocol routers within a routing protocol area.

18. The method of claim 17, wherein the displaying includes:
displaying multiple routing protocol areas.

19. The method of claim 17, wherein the displaying includes:
displaying a routing protocol area connected to a backbone routing protocol router.

20. The method of claim 17, comprising:
selecting between a first view showing routing protocol routers within the routing protocol area, and a second view showing the routing protocol area connected to a backbone routing protocol router.

21. Apparatus for discovering routers which support a first routing protocol to produce a topology of a portion of the computer network which supports a first routing protocol, comprising:
means for obtaining first information from a first router that supports the first routing protocol in the computer network, the routing protocol defining areas which are groups of routers and defining neighbors, the first information including a first routing protocol neighbor indication and a first routing protocol area indication, the processor configured to use the first routing protocol neighbor indication to determine a second router that supports the first routing protocol in the computer network, the processor configured to obtain second information from the second router, the second information including a second routing protocol neighbor indication and a second routing protocol area indication; and
means for storing the first and second information to produce topology information of a portion of the computer network that supports the first routing protocol.

22. Apparatus of claim 21, wherein the first routing protocol is an OSPF protocol.

23. Apparatus of claim 7, comprising:
means for using the topology information to show a routing protocol area.

24. Apparatus of claim 23, wherein the using means shows routing protocol nodes within the routing protocol area.

25. Apparatus of claim 23, wherein the using means shows multiple routing protocol areas.

26. Apparatus of claim 23, wherein the using means shows the routing protocol area connected to a backbone routing protocol router.

27. Apparatus of claim 23, wherein the obtaining means includes an interface for selection between a first view showing routing protocol routers within the routing protocol area and a second view showing the routing protocol area connected to a backbone routing protocol router.

28. Apparatus of claim 24, wherein the first routing protocol is an OSPF protocol.
